(19) United States
(12) Patent Application Publication
(10) Pub. No.: US 2006/0076511 A1
(43) Pub. Date: Apr. 13, 2006

(54) Shallow angle cut along a longitudinal direction of a feature in a semiconductor wafer

(75) Inventors: Peter G. Borden, San Mateo, CA (US); Cecilia C. Martner, Los Gatos, CA (US)

Correspondence Address: PATENT COUNSEL;APPLIED MATERIALS, INC., MS/2061, Legal Affairs Dept., PO BOX 450A, SANTA CLARA, CA, 95052, US

(73) Assignee: APPLIED MATERIALS, INC.

(21) Appl. No.: 10/962,164

(22) Filed: Oct. 8, 2004

(51) Int. Cl. G21K 7/00

(52) U.S. Cl. 250/492.21; 250/309

(57) ABSTRACT

A cut of a longitudinal feature (such as a trench in a semiconductor wafer), is made not perpendicular to or parallel to the feature, but instead at an angle to the longitudinal direction of the feature. Specifically, if the longitudinal feature is oriented along an X axis, then several embodiments cut the feature along a shallow angle θ relative to the X axis, to form a cross-section of the feature that is substantially elongated. The amount of elongation of the cross-section depends on the shallowness of angle θ. Specifically, the shallower the angle θ, the more elongated the cross-section. Such an elongated cross-section is evaluated by a tool whose resolution limit has been reached and which tool cannot be used to evaluate a normal cross-section of the feature. Therefore resolution-limited tools have an extended life by use of shallow angle cuts as device geometries shrink below their resolution limits.

### BACKGROUND

In a conventional damascene interconnect process, a trench 100 is etched into a dielectric layer 101 as shown in FIGS. 1A and 1B. Note that the dielectric layer 101 may have formed thereon a hard mask layer 104 as shown in FIG. 1B. The smallest of trenches, in current technology known to the inventors, can be on the order of 1200 Å wide and 3000 Å deep. Such a trench 100 contains a layer 102 of barrier material such as TaN, underneath a thin copper seed layer 103. The barrier layer 102 enhances copper adhesion when copper seed layer 103 is formed in trench 100 and prevents diffusion of copper into the dielectric. The seed layer 103 is a highly conductive layer that provides a current path so that copper can be plated into trench 100 to fill it and form a metal line therein. Finally, excess copper and barrier material is polished from the surface to define a trench filled with copper (i.e. the metal line, which is not shown in FIGS. 1A and 1B). The metal line typically interconnects portions of electronic device(s) within a semiconductor wafer.

The above-described barrier/seed (b/s) deposition is a critical part of this process, and requires careful control of the thickness, profile, and coverage of the coating in the trench. The thicknesses Tb and Ts of layers 102 and 103 respectively (see FIG. 1A) may be a few tens of angstroms when measured perpendicular to the plane of a top surface of wafer 191 (i.e. in the vertical direction Y in FIG. 1A). Barrier and seed layer thicknesses Tb and Ts are typically smaller in the vertical regions on the sidewalls 101A and 101B of dielectric layer 101 (FIG. 1A). Because the barrier and seed layers are so thin, traditional methods measure thickness by use of a transmission electron microscope (TEM). In this technique a sample (not shown) is prepared by cutting and lifting a very thin section of the wafer 191 using ion milling. The section is typically formed by making two cuts in a direction perpendicular to the longitudinal direction of the trench, e.g. in the direction Y in FIG. 1A. This sample (not shown) is lifted out carefully and examined in a TEM. The procedure is relatively slow, costly, labor intensive, and takes several hours to prepare each sample. Because of the extremely high magnification of TEM, the thickness of barrier and seed layers at sidewalls 101A and 101B are measured directly in an image generated by the TEM (e.g. in the direction Y in FIG. 1B).

Procurement of a sample from a wafer 191 and the related labor intensive handling of the sample takes several hours per sample, and this process is avoided by use of a focused ion beam (FIB) to make a cut in the wafer, followed by observation of a vertical surface in the wafer formed by the cut, through a scanning electron microscope (SEM) by use of the apparatus shown in FIG. 2A. In such an apparatus (e.g. Applied Materials G2) the FIB is used to destructively remove a wedge shaped portion 290 of the wafer, in a direction perpendicular to the longitudinal direction of a trench 100, as shown in FIG. 2B. Removal of portion 290 (by ion milling) exposes a surface 291 which is to be observed by the SEM. Surface 291 is perpendicular to the top surface 190 of wafer 191, and therefore this surface is oriented vertically whenever the wafer is horizontal. As a byproduct of the milling process, a surface 292 is formed but it cannot be easily observed because some of the material being removed from surface 291 falls (or becomes re-deposited) thereon.

Then the SEM is used to observe surface 291 which is perpendicular to the top surface 190 of the wafer. Note that surface 292 of the cut is typically oriented at a large angle e.g. 45° relative to the top surface 190.

In the procedure of the previous paragraph, the SEM is normally oriented to obtain a view of surface 291 in a direction parallel to surface 292. SEM images illustrating the view are shown in FIGS. 2C-2F. As shown therein, it is somewhat difficult to resolve between a barrier layer 102 and a seed layer (portions of which are individually identified at the top as 103T and at the side as 103S). A blurring artifact is produced by the SEM in the region of the barrier and seed layer adjacent to the surfaces 102A and 102B of the dielectric layer.

Methods and structures involving sample preparation and microscopy are described in, for example, U.S. Pat. No. 6,426,500 issued to Chang et al on Jul. 30, 2002, U.S. Pat. No. 5,990,478 issued to Liu on Nov. 23, 1999, U.S. Pat. No. 5,798,529 granted to Wagner on Aug. 25, 1998, and U.S. Pat. No. 6,794,663 granted to Shichi et al. on Sep. 21, 2004, each of which is incorporated by reference herein in its entirety as background.

### SUMMARY

A cut of a longitudinal feature (such as a trench in a semiconductor wafer), is made in accordance with the invention, not perpendicular to the feature, but instead at an angle to the longitudinal direction of the feature. Specifically, if the longitudinal feature is oriented along an X axis, then several embodiments of the invention cut the feature along a shallow angle θ relative to the X axis, to form a cross-section of the feature that is substantially elongated. The amount of elongation of the cross-section depends on the shallowness of angle θ. Specifically, the shallower the angle θ, the more elongated the cross-section, as angle θ approaches a lower limit of zero.

The inventors realize that an elongated cross-section obtained by a shallow angle cut as described in the previous paragraph can be evaluated by a tool whose resolution limit has been reached and which tool cannot be used to evaluate a normal cross-section of the feature (obtained by a conventional cut that is made perpendicular or substantially perpendicular to the feature's longitudinal direction). Specifically, a tool continues to be used in many embodiments of the invention, even when device geometries shrink below the resolution limit of the tool, simply by making a cut at an angle (90°−θ) relative to the direction of measurement, with θ made sufficiently small to provide a sufficiently large elongation factor.

### BRIEF DESCRIPTION OF THE FIGURES

FIG. 1A illustrates, in a plan view a portion of semiconductor wafer wherein one or more cuts are made in a direction perpendicular to a longitudinal direction (along the X-axis) of trench 100.

FIG. 1B illustrates, in a side perspective view a cut vertical surface of FIG. 1A when seen from the top in the direction—X in FIG. 1A.

FIG. 2A illustrates, in a block diagram, a prior art tool containing a Focused Ion Beam (FIB) and a Scanning Electron Microscope (SEM).

FIG. 2B illustrates, in a perspective view, a portion of a wafer which has a cut 290 made by the FIB of FIG. 2B and a surface 291 which is observed by the SEM of FIG. 2B, in a prior art method.

FIGS. 2C-2F illustrate images of the prior art generated by perpendicular cuts in four dies of a wafer (respectively located at top, center, right and bottom) which cuts were made by a focused ion beam (FIB) and imaged with a scanning electron microscope (SEM).

FIGS. 3A and 3B illustrate, in a plan view and a side perspective view respectively, a cut 310 made at an oblique angle θ in accordance with the invention showing an elongated cross-section of trench 100 with barrier and seed sidewalls shown elongated along the X-axis and having thicknesses Tb/sin θ and Ts/sin θ respectively, wherein angle θ is defined in a plane parallel to a top surface of the wafer.

FIG. 3C illustrates a relationship between an angle θ in the plan view at which a cut is made in the direction B-B which results in an elongated cross-section D as compared to a normal cross-section C obtained by a normal cut in the direction A-A.

FIGS. 4A and 4B illustrate in a plan view a portion of a semiconductor wafer before and after a FIB cut made at angle θ in accordance with the invention, whereby an elongated region 402 of the trench side wall 100B is visible in direction V in FIG. 4B after the cut and is evaluated for non-uniformities in coverage thereon by layers 102 and 103.

FIGS. 4C and 4D illustrate, in a line drawing and a SEM image respectively, a surface formed by the cut in FIG. 4A viewed in the direction V in FIG. 4B in wafers without and with a capping layer respectively.

FIGS. 4E and 4F illustrate, SEM images from wafers prepared in the same manner as FIG. 4D, at two locations in a wafer not having a capping layer.

FIGS. 5A-5D illustrate SEM images prepared in the same manner as FIG. 4D, from the same locations at which prior art images of FIGS. 2C-2F are prepared.

FIGS. 6A and 6B illustrate, in a line drawing and a SEM image respectively, a FIB cut formed across a number of trenches in accordance with the invention, at an angle +θ and −θ respectively, relative to a longitudinal direction of the trenches.

FIG. 7 illustrates, in a flow chart, acts performed in several embodiments of the invention.

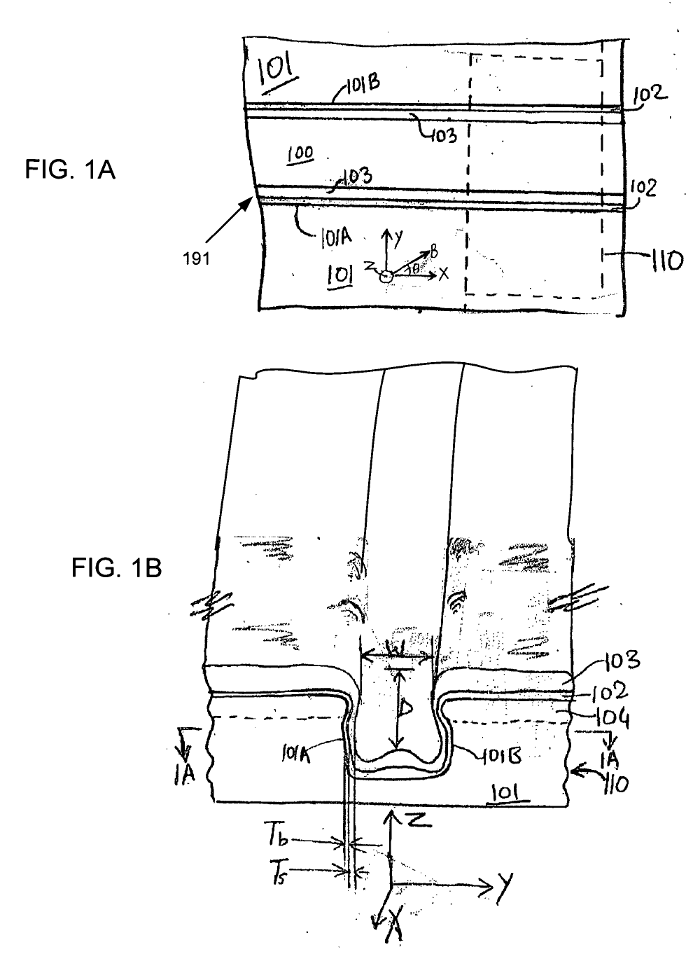

### DETAILED DESCRIPTION

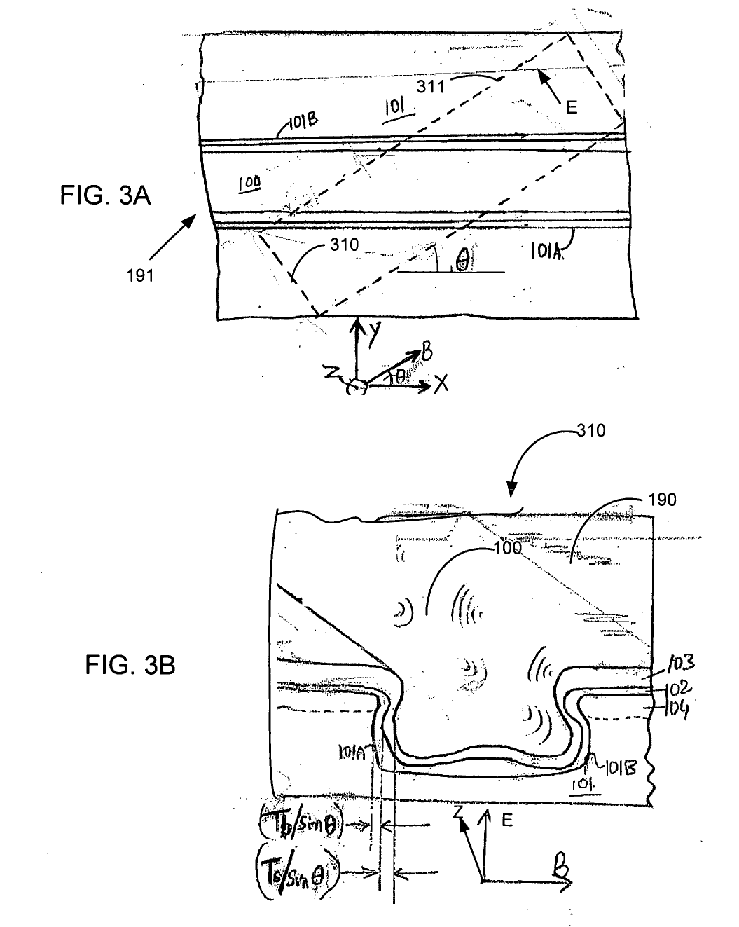

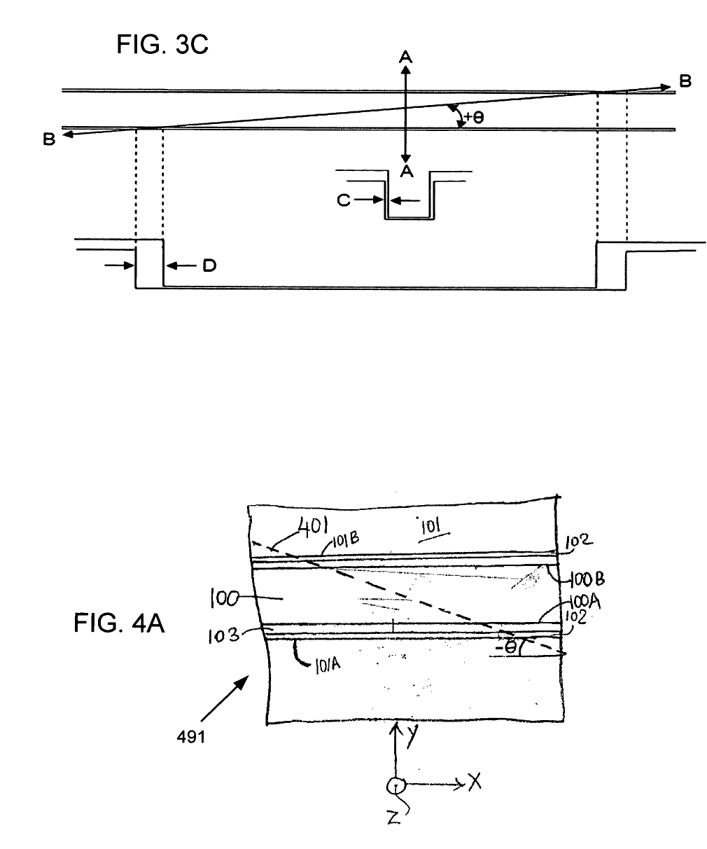

In accordance with the invention, a semiconductor wafer 191 (FIG. 3A) having one or more longitudinal features (such as a trench 100 in semiconductor wafer 191) is cut (for example to obtain a view for observation in a SEM), not perpendicular to the longitudinal feature(s), but instead at a small angle θ (e.g. 30°) relative to the longitudinal direction. Specifically, in FIG. 3A, trench 100 is oriented along the X axis, and hence a view of surface 311 in wafer 191 is obtained by a cut 310 in a direction B along a shallow angle θ relative to the X axis. The shallow angle cut provides a view as shown in FIG. 3B which when viewed in a SEM (in negative E direction which is perpendicular to cutting direction B) shows an elongated cross-section of trench 100 and its sidewall coatings 102 and 103.

The elongated cross-section may be evaluated in the normal manner except for certain differences noted herein. Measurements of dimensions of barrier layer 102 and seed layer 103 that are obtained from view formed by cut 310 are distorted along the axis parallel to the surface due to elongation by a factor of 1/(sin θ). Note that for small values, sin θ is approximately θ in radians, and for this reason the just-described factor may be approximated to 1/θ in some embodiments. Specifically, the quantities being measured are Tb/sin θ and Ts/sin θ wherein Tb and Ts are respectively the barrier layer thickness and the seed layer thickness in a normal cross-section. Therefore, in some embodiments, measurements made on such an elongated cross-section D (see FIG. 3C) are scaled down (by dividing the measurements with the above-described factor) to obtain measures of thicknesses of a normal cross-section C. In FIG. 3C, the elongated cross-section D is obtained by cutting in the direction B-B, whereas a normal cross-section C would have been obtained if a cut were made in the direction A-A.

In many embodiments of the invention, the cross-section being observed is elongated several times (e.g. 2-5 times, 10-20 times, or 100-500 times or even 5000 times), wherein the elongation factor depends on angle θ. In the above-described example, when angle θ is 30°, the cross-section is elongated by a factor of 2. Angle θ can theoretically have any value between zero and 90° (but not equal to these two limits). Specifically, the shallower the angle θ, the more elongated the cross-section, as angle θ approaches its lower limit of zero. Note that at the lower limit of zero, the cut becomes parallel to the feature (or passes through the feature) and elongation becomes infinite, which is avoided. Note also that as the elongation scales inversely with sin(θ), which approximately equals θ for small angles, that the accuracy of setting θ must be increasingly precise as θ gets smaller in order to properly calibrate the distance scale of the measurement.

Note that the angle of the cut θ (relative to a longitudinal direction of the feature) may be made as small as necessary other than zero, depending on the elongation desired, if the feature being cut is sufficiently long. For example, a first embodiment uses an angle of θ=30° to provide an elongation factor of 2.00 whereas a second embodiment uses an angle of θ=6° to provide an elongation factor of 9.57, and a third embodiment uses an angle of θ=3° to provide an elongation factor of 19.11. In some embodiments the limits in accuracy at which a cut can be formed relative to the longitudinal direction of the feature being evaluated permit an angle θ=0.50 to be used and therefore provide an elongation factor of 114.59 whereas other embodiments have accuracy and resolution limits on θ that permit an angle θ=0.1° to be used and therefore provide an elongation factor of 572.96.

Note that θ=0.1° is not a lower limit, and instead it is merely illustrative of the shallow angle used in some embodiments. Specifically, several commercially available tools of the type described herein contain rotary stages that provide accuracy and resolution of the type described herein. Embodiments of the type described herein may use an angle in the range 0.1°<θ<0 as long as other limits (such as length of the feature) are not reached. If the an elongated dimension is M+δM, where δM is the error, and the angle is θ+δθ, where δθ is the sample angular error, then the fractional error in elongation equals the fractional error in angle for small angles: δM/M=δθ/θ. This sets the limit of the usable angle. For example, if the magnification must be accurate to 10%, then the angle positioning error must be less than or equal to 10%.

An angle θ>30° is not used in most embodiments, because although an elongation factor greater than 1 is present in the range 30°<θ<90°, the elongation factor is less than 2 and hence not very advantageous. In most embodiments of the invention, the cross-section obtained by a shallow angle cut is elongated several times, and in some embodiments it is elongated by one or more orders of magnitude.

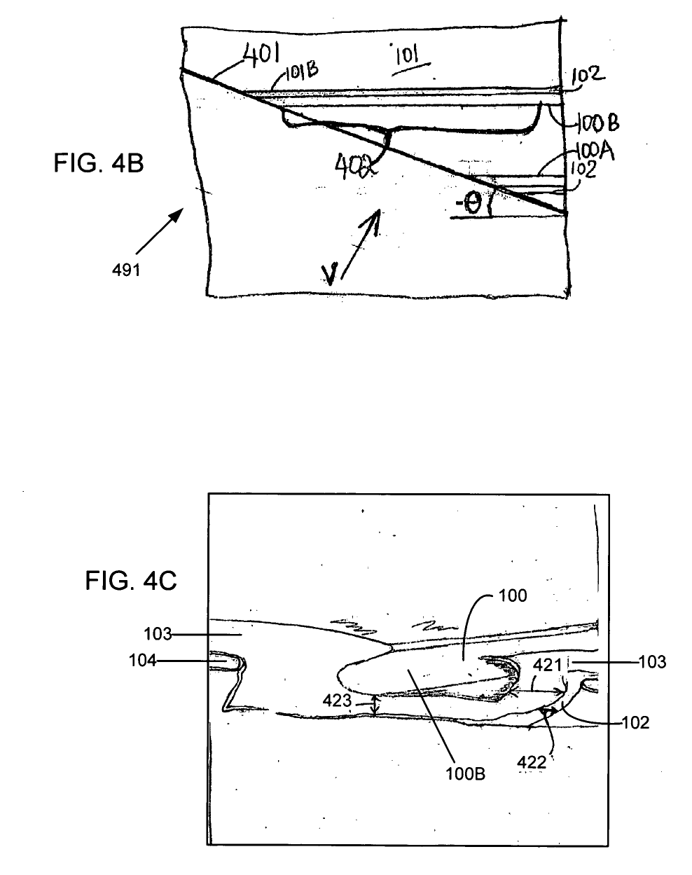

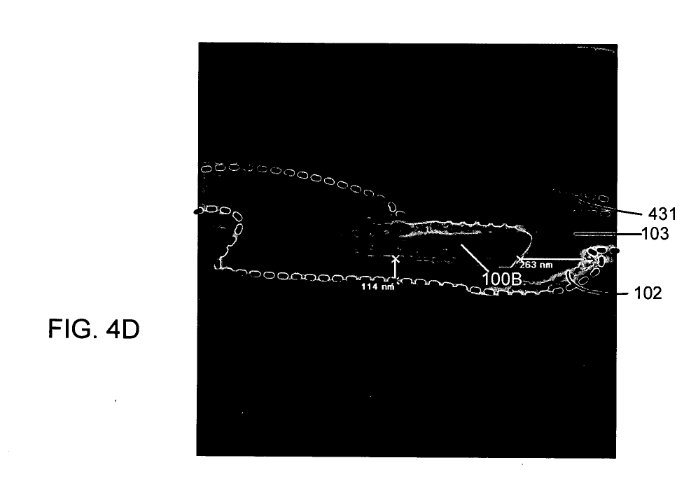

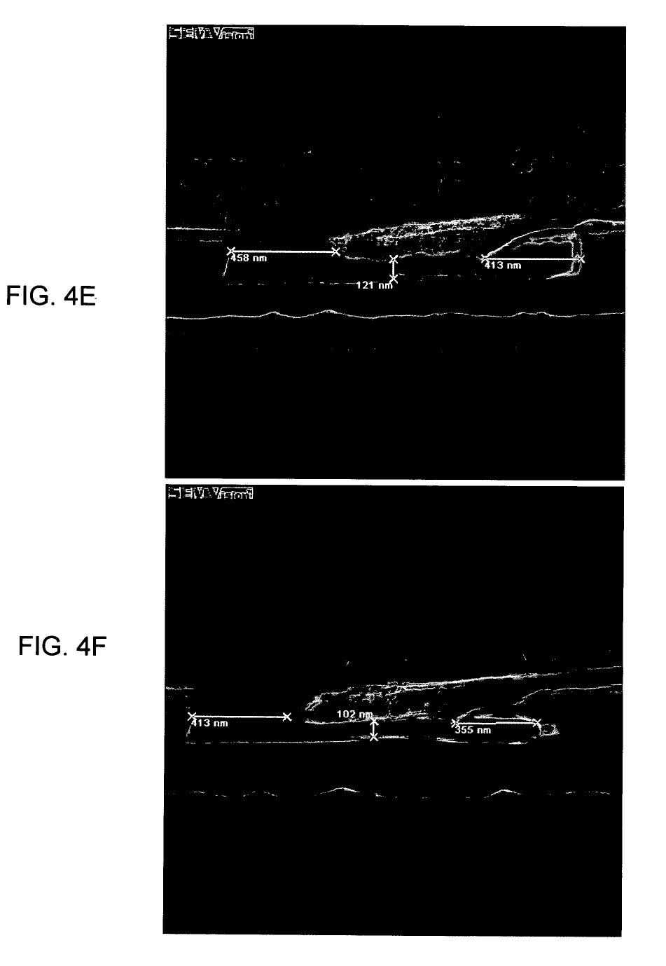

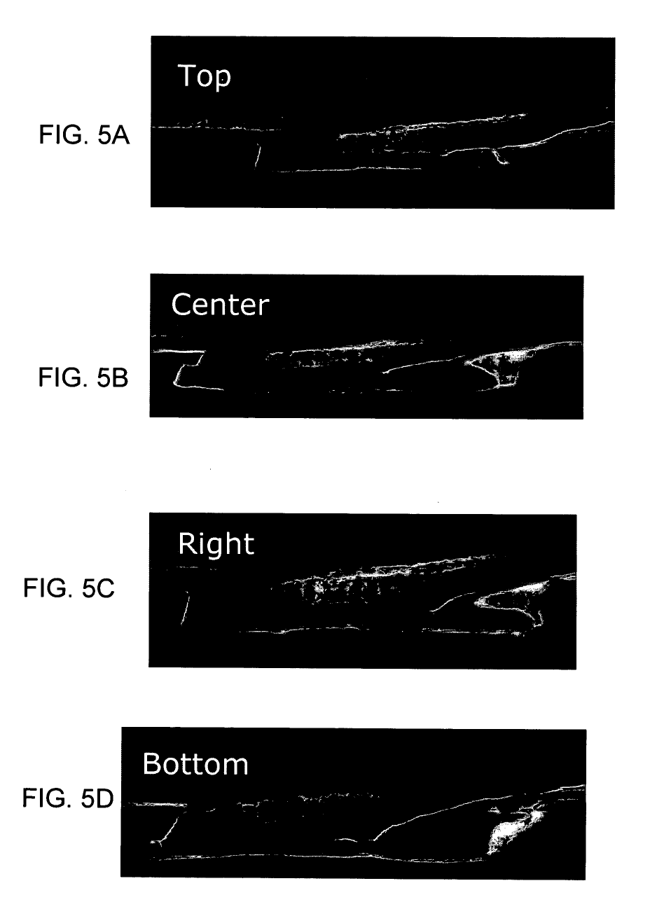

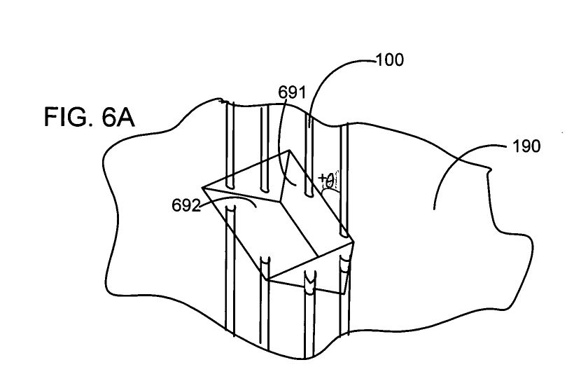

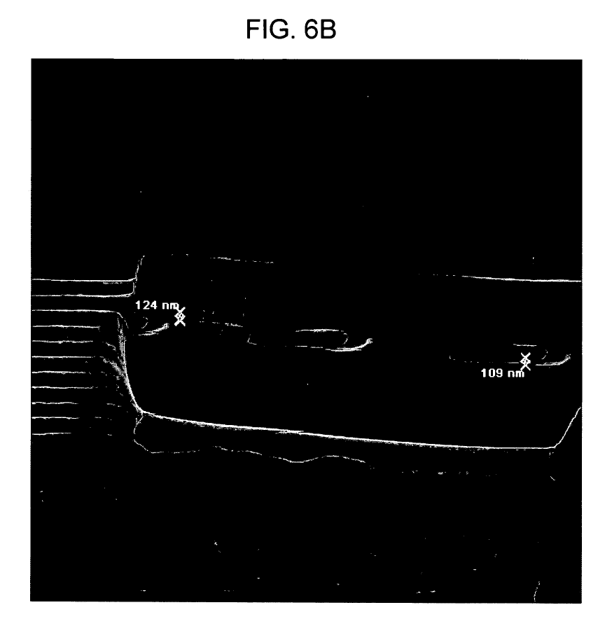

Although a cut is illustrated in FIGS. 3A-3C at a positive angle θ relative to the X axis (see FIG. 3A), a similar cut can be alternatively (or additionally) made in the negative angle θ relative to the X axis as illustrated by line 401 in FIG. 4A. Furthermore, several embodiments may use FIB cuts of the type shown in FIGS. 6A and 6B to expose a vertical surface 691 to be viewed in a SEM as will be apparent to the skilled artisan in view of this disclosure. FIG. 4B illustrates wafer 491 after a FIB cut along line 401 is made by cutting away at the bottom left corner of the figure. Note that the SEM is used to view, in the direction V in FIG. 4B, a vertical surface of wafer 491 that is formed by the FIB cut at line 401.

An image generated by the SEM when viewing as discussed in the previous paragraph is shown in FIG. 4C. In some embodiments, the elongated cross-section of FIG. 4B is evaluated by measuring a dimension of the feature in the X direction. For example, the distances 421 and 422 are measured to be used in computing Ts and Tb respectively. An X direction measurement in the elongated cross-section, when divided by (1/sin θ), yields a measure of the dimension in a normal cross-section of the feature. For example, if a shallow angle cut is made at θ=6° relative to the length of a sidewall, then a measurement of sidewall's dimension is made in the elongated cross-section, and the measurement is divided by 10.45, because sin(6°)=0.1045, to obtain a conventional measure of the sidewall's thickness.

An actual SEM image of a FIB cut of the type shown in FIG. 4C is shown in the SEM image of FIG. 4D. Note that a capping layer 431 is present in this SEM image of FIG. 4D. On the other hand, in the embodiment of FIG. 4C, the cut is done with an empty groove (also called trench) 100. In the embodiment of FIG. 4D, prior to making the cut, a capping 431 layer in the form of dielectric film or conductive film is deposited (or otherwise formed) over the top surface to fill the trenches with a dielectric material such as SiO2 or a conductive material such as Platinum. The capping layer provides additional rigidity to prevent deformation of trenches as the cut is made.

Several embodiments of the type described herein use a tool which has a rotating stage (as does the Applied Materials G2 SEM), and expands the apparent sidewall thickness from distance C to distance D, where D=C/sin(θ). Note that distances C and D are shown in FIG. 3C. For example, if θ=1 degree, then D=57.3 C. If C=50 Å, then D=2865 Å, which is easily measured with a conventional SEM. The cut length B-B must be at least 9 μm to fully cover a trench of width W=0.14 μm.

Note that once a wafer is rotated to the proper angle, several cuts may be quickly made and imaged. Therefore, it is possible to measure coverage uniformity or coverage in different structures quickly. The method has other advantages as well. It is not necessary to align the cut to a given groove. A sufficiently long cut will go through several grooves automatically providing a section of the image that shows a cut through a single groove. For example, three grooves are seen in FIG. 6B. In addition, the picture shows the sidewall in between the two ends, so that additional information on the quality of coverage in the sidewall is obtained.

In several embodiments, an elongated cross-section of the type-described-h-erein is evaluated by inspecting coverage of a sidewall by a layer formed thereon. Specifically, the layer in the elongated cross-section is visually inspected for non-uniformities, and if no non-uniformities are found then the wafer is processed further in the normal manner. If one or more non-uniformities (such as a spotty pattern of a barrier layer or a seed layer) are found then one or more corrective actions are taken (to fix the wafer under evaluation and/or to improve fabrication of future wafers). In the above example, if θ=6° then a length of the sidewall available for inspection is almost equal to the length in the elongated cross-section. Such visual inspection of the sidewall visible through the elongated cross-section eliminates a series of cuts that are conventionally required to evaluate coverage of this much length of the sidewall. Moreover, such visual inspection of a view generated by a shallow angle cut is also significantly easier than making a cut through and parallel to a trench. As device geometries shrink it becomes increasingly difficult to precisely control a cut to ensure that cutting is stopped within the gap of the trench which is required for making parallel cuts. In contrast, making a cut at an oblique angle as described herein is easy, once the wafer is properly aligned relative to the cutting tool (such as FIB).

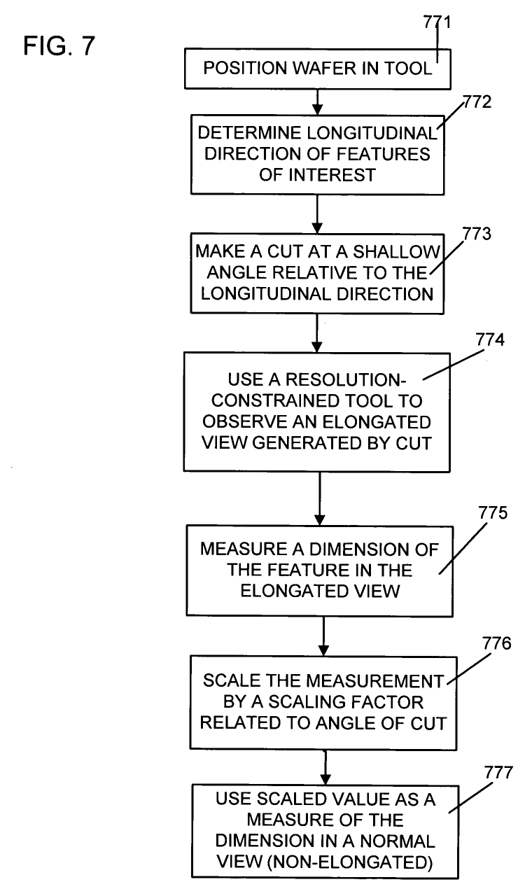

In some embodiments, the acts illustrated in FIG. 7 are performed as follows. In act 771, a wafer is positioned in the tool. Next, in act 722, the longitudinal direction of the features of interest is determined. Typically such features are trenches or metal lines that are parallel or perpendicular to a reference direction of the wafer. Next, a cut is made, as per act 773, at the above-described shallow angle θ. Then a resolution-constrained tool is used in act 774 to view the elongated cross-section.

In several embodiments, an elongated dimension therein (such as Tb/sin θ) is measured in act 775. Next, in some such embodiments, in act 776 the measurement is divided by the elongation factor to obtain a measure of the normal dimension. The scaled value is used in act 777 as if the normal dimension had been measured, e.g. to compare against limits on the dimension specified in a manufacturing specification for the wafer.

Note that an inverse of the elongation factor (i.e. 1//sin θ) is sometimes referred to as a scaling factor (i.e. sin θ). Note also that the length of a feature may limit the elongation factor that can be used in some embodiments. For example, if a trench is 20 microns in length and 0.12 micron in width then the smallest angle θ at which a cut is made in these embodiments is limited to 0.02 degree.

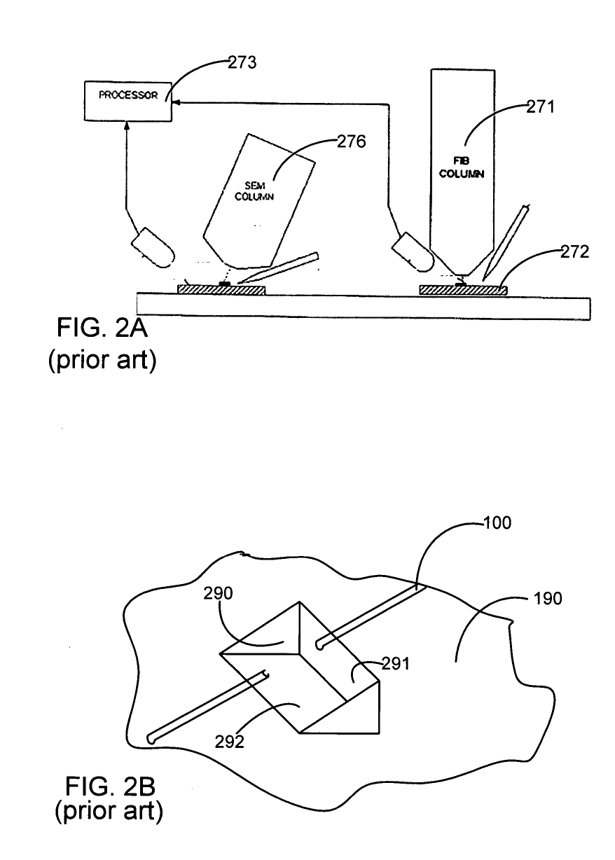

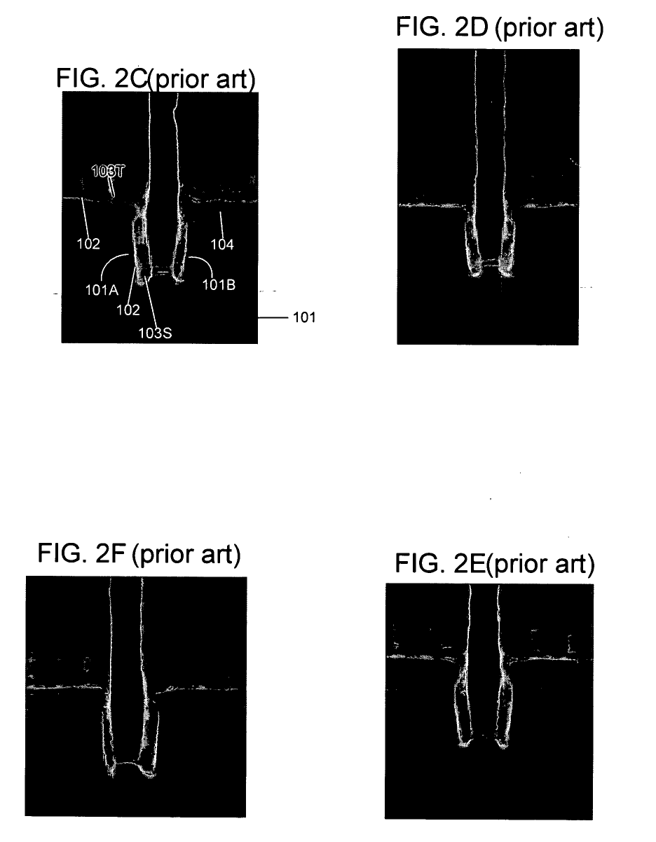

Note that while method of FIG. 7 can be performed in any manner, in some embodiments several acts are automated by appropriate programming of a processor of an apparatus of the type shown in FIG. 2A. In such embodiments, the apparatus includes a source of a focused ion beam such as the FIB column 271 of FIG. 2A, a stage for supporting the semiconductor wafer at a position in a path of the focused ion beam (which is shown in FIG. 2A as stage 272 located underneath FIB column 271). Such an apparatus also includes a processor 273 which is coupled to the stage 272 by a bus (not shown) for providing signals to orient the semiconductor wafer to form a shallow angle θ between a longitudinal direction of the feature and a direction of cut of the focused ion beam. The apparatus further includes a microscope (such as SEM 276 in FIG. 2A) for viewing a vertical surface in the semiconductor wafer exposed by the cut. The programming of processor 273 to quickly and repeatedly perform act 773 (described above) will be apparent to a skilled artisan. Thereafter, a wafer containing a number of shallow angle cuts (e.g. at a number of different dies therein)

Numerous modifications and adaptations of the embodiments described herein will be apparent to the skilled artisan. Note that although some embodiments rotate a wafer through angle θ, in other embodiments a cutting tool such as a FIB may be rotated through angle θ relative to a stationary wafer (either by rotating the FIB column or by appropriately changing an electrical field within the FIB column) to form a cut in the wafer at angle θ. Furthermore, instead of scaling just measurements, an SEM image as a whole is scaled in the X direction in some embodiments, thereby to generate an image of the type generated from a normal cross-section of the prior art. Note that such an SEM image may also be scaled in another direction (such as the Y direction or the Z direction) if the surface is viewed at other than normal (for example if the SEM views the vertical surface at 45° then a corresponding scaling is also done in the normal manner). Also instead of scaling down an elongated dimension measurement before comparing to limits in a manufacturing specification, such limits may be scaled up and compared to the measurement. Therefore, numerous such modifications and adaptations are encompassed by the attached claims.

1. A method for evaluating a semiconductor wafer comprising a feature, the method comprising:
making a cut passing through the feature at a shallow angle θ relative to a longitudinal direction of the feature;
wherein angle θ is defined in a plane parallel to a top surface of the wafer;
observing the feature, in a view exposed by the cut.

2. The method of claim 1 wherein the observing comprises:
measuring a plurality of dimensions of the feature at different locations in said view; and
scaling each measurement obtained from said measuring, by a common scaling factor related to angle θ, to obtain a scaled value corresponding to said each measurement; and
using each scaled value as a measure of a corresponding dimension of the feature in a view perpendicular to the longitudinal direction.

3. The method of claim 2 wherein the scaling factor comprises sin θ.

4. The method of claim 2 wherein the scaling factor comprises θ in radians.

5. The method of claim 1 wherein the observing comprises:
visually inspecting for non uniformities in coverage.

6. The method of claim 2 wherein the measuring comprises:
using a tool incapable of resolving to the scaled value.

7. An apparatus for evaluating a semiconductor wafer comprising a feature, the apparatus comprising:
a cutting tool;
a stage for supporting the semiconductor wafer at a position in a path of the cutting tool;
a processor coupled to the stage for providing signals to orient the semiconductor wafer to form a shallow angle θ between a longitudinal direction of the feature and a direction of cut of the cutting tool; and
a microscope for viewing a vertical surface in the semiconductor wafer exposed by the cut;
wherein angle θ is defined in a plane parallel to a top surface of the wafer.

8. The method of claim 1 wherein:
the feature comprises at least one of (trench and metal line).

9. The method of claim 1 wherein:
the feature comprises a sidewall having a thickness T; and
an elongated dimension [T/(sin θ)] is measured during said observing.

10. The method of claim 1 wherein:
the feature comprises a barrier layer of thickness Tb and a seed layer of thickness Ts; and
at least two elongated dimensions [Tb/(sin θ)] and [Ts/(sin θ)] are measured during said observing.

11. The method of claim 10 wherein:
the seed layer is highly conductive to provide a current path.

12. The method of claim 1 wherein:
the feature is one of a plurality of features in the semiconductor wafer; and
the cut is made across said plurality of features without aligning to said feature.

13. The apparatus of claim 7 wherein:
the microscope comprises a scanning electron microscope.

14. The apparatus of claim 7 wherein:
the stage is a rotating stage.

15. The apparatus of claim 7 wherein:
the cutting tool comprises a source of a focused ion beam.

16. The apparatus of claim 7 wherein:
the microscope is incapable of resolving to a dimension of the feature in a direction perpendicular to the longitudinal direction.

17. The apparatus of claim 7 wherein:
the feature comprises a sidewall having a thickness T; and
an elongated dimension [T/(sin θ)] is exposed in a horizontal direction in the vertical surface.

18. The apparatus of claim 7 wherein:
the feature comprises a barrier layer of thickness Tb and a seed layer of thickness Ts; and
at least two elongated dimensions [Tb/(sin θ)] and [Ts/(sin θ)] are exposed in the vertical surface.
